(19) United States
(12) Patent Application Publication
(10) Pub. No.: US 2014/0283585 A1
(43) Pub. Date: Sep. 25, 2014

(54) UNDERWATER DETECTION APPARATUS

(71) Applicant: Frank Tore Sæther, Bergen (NO)

(72) Inventor: Frank Tore Sæther, Bergen (NO)

(73) Assignee: NAXYS AS, Bergen (NO)

(21) Appl. No.: 14/236,459

(22) PCT Filed: Jul. 18, 2012
(86) PCT No.: PCT/NO2012/050138

§ 371 Date: May 8, 2014

(30) Foreign Application Priority Data
Aug. 2, 2011 (GB) 1113278.4
Aug. 2, 2011 (NO) 20111092

(51) Int. Cl. G01V 11/00; G01V 1/00

(52) U.S. Cl. CPC G01V 11/00; G01V 1/001
USPC 73/61.43; 73/61.41; 73/61.79

(57) ABSTRACT

An underwater detection apparatus for detecting a presence of one or more bubbles within an aquatic environment includes a first structure including a lower peripheral edge for defining an area over which the apparatus is operable to collect the one or more bubbles, a second structure for spatially concentrating the one or more bubbles received within the area defined by the lower peripheral edge into a detection region, and a detection arrangement for detecting the one or more bubbles concentrated in operation by the bubble concentrating structure passing into the detection region and generating an output signal indicative of the one or more bubbles passing through the detection region. The apparatus is optionally mounted upon an aquatic remotely operated vehicle (ROV). The apparatus is beneficially employed for investigating sources of one or more bubbles in aquatic environments, for example from oil exploration and/or production leaks, from damaged electrical subsea cables, from leaks from seabed gas pipelines and similar.

### FIELD OF THE INVENTION

The present invention relates to underwater detection apparatus, for example to underwater detection apparatus for detecting a presence of bubbles arising from underwater facilities and from seabed regions. Moreover, the present invention concerns methods of using aforesaid apparatus for detecting a presence of bubbles. Furthermore, the invention relates to software products recorded on machine-readable media, wherein the software products are executable on computing hardware for implementing aforesaid methods.

### BACKGROUND OF THE INVENTION

It is well known that bubbles occur in liquids. Moreover, it is well known that bubbles arise naturally in water-covered regions, for example in swamps and lagoons as a result of decaying organic vegetation giving rise to methane gas. It is perhaps less appreciated that bubbles are also generated naturally in ocean environments, but are not noticed in view of seemingly chaotic ocean surface wave motion. In ocean environments, the formation of bubbles can be indicative of various processes occurring below a seabed, for example geological fissures along tectonic fault lines, geological processes such as hot-water springs, and such like.

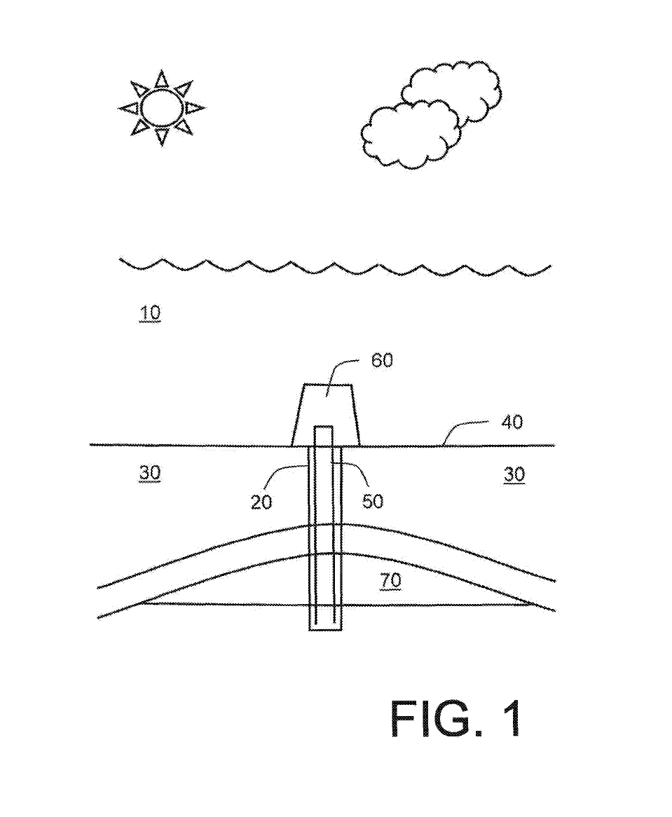

When offshore drilling for gas and/or oil is performed in an ocean environment 10 as illustrated in FIG. 1, a borehole 20 is drilled into a geological formation 30 having an upper surface forming a seabed 40. It is customary practice to line the borehole 20 with a steel liner tube 50. In deep-water installations, it is also conventional practice to cap the liner tube 50 at the seabed 40 with a valve arrangement 60. The valve arrangement 60 is often referred to as being a “Christmas Tree” on account of its superficial likening to an upwardly tapered form of a coniferous tree. The geological formation 30 spatially adjacent to the borehole 20 is often porous in nature and unable to withstand high pressures which arise within the liner tube 50, especially when an oil and/or gas reserve 70 intercepted by the borehole 20 is in its early stage of production and at high intrinsic pressure. In later stages of production from the oil and/or gas reserve, it is often necessary to inject fluids into the oil and/or gas reserve 70 at considerable pressure which causes a high internal pressure to be experienced by the liner tube 50. The valve arrangement 60 enables flexible pipes to be attached to the liner tube 50 via the valve arrangement 60, for example when a floating oil and/or gas production platform is employed.

As experienced in the Deep Water Horizon accident in the Gulf of Mexico in the year 2010, the liner tube 50 can leak or even fracture. Such fracture can arise from manufacturing defects in a material employed to fabricate the liner tube 50, or can arise from the liner tube 50 being stressed beyond its design ratings (for example by excess pressure being applied to cause greater production rates from the oil and/or gas reserve 70) during operation. When the liner tube 50 becomes fractured, fluids from the borehole 20 leak into neighbouring regions of the geological formation 30 and is experienced often as a loss of pressure within the borehole 20. Eventually, the fluids from a fracture in the liner tube 50 seep to the seabed 40 and appear as issuance of occasional bubbles over an expansive area of the seabed 40. In view of optical visibility at the seabed 40 often being obscured by particulate matter, especially when there are activities which disturb sediment on the seabed 40, these occasional bubbles are sometimes difficult to detect using conventional techniques. Crude oil is known to exsolve gas bubbles when it becomes depressurized, and such exsolved gas generated within the geological formation 30 close to the borehole 20 can potentially disturb particulate matter on the seabed 40 and thereby cause optical obscuration.

Similar considerations also pertain to underwater pipelines for oil and/or gas which, after many years of use, can develop occasional defects, for example “pin holes” from where leaks of gas can occur. It is highly desirable to detect small leaks and repair them, before they develop into major leaks causing significant environmental damage. However, in a similar situation to FIG. 1, detecting occasional leaks over an extensive area of seabed 40 in optically-obscured conditions is potentially a difficult technical problem to address.

It will be appreciated from the foregoing that there is a need for robust apparatus which is capable of operating in ocean environments 10 and detecting bubbles issuing from an extensive area of the seabed 40 in the concurrent presence of particular material which can cause aforesaid optical obscuration.

US 2003/0056568 A1 disclose a method for detecting a marine gas seep by deploying a local probe on the seafloor and producing bubbles in the water near the probe, and detecting the bubbles and estimating the concentration of dissolved gas in the water, and comparing with the nearby marine gas seep.

GB 2176604 A discloses acoustic detection of gas leaks, by using a passive and active sonar detection system mounted externally of a pipeline.

### SUMMARY OF THE INVENTION

The present invention seeks to provide an improved apparatus which is operable to collect and detect in a reliable manner one or more bubbles in an aquatic environment.

According to a first aspect of the present invention, there is provided an underwater detection apparatus as defined in appended claim 1: there is provided an underwater detection apparatus for detecting a presence of one or more bubbles within an aquatic environment, characterized in that the apparatus includes a first structure including a lower peripheral edge for defining an area over which said apparatus is operable to collect the one or more bubbles, a second structure for spatially concentrating the one or more bubbles received within the area defined by the lower peripheral edge into a detection region, and a detection arrangement for detecting the one or more bubbles concentrated in operation by the bubble concentrating structure passing into the detection region and generating an output signal (S2) indicative of the one or more bubbles passing through the detection region.

The invention is of advantage in that the underwater detection apparatus is operable to collect the one or more bubbles over a potentially extensive area within the aquatic environment, and to detect the bubbles in a manner which is robust to particulate contamination within the aquatic environment.

Optionally, the apparatus is adapted to detect at least one of: one or more gas bubbles, one or more oil bubbles. “Oil” here is to be interpreted to include a broad range of fluid hydrocarbon materials.

Optionally, in the underwater detection apparatus, the second structure is implemented as a substantially frusto-conical structure for spatially defining a volume in which the one or more bubbles are concentrated in operation.

Optionally, in the underwater detection apparatus, the detection arrangement includes one or more sensors for passively detecting sounds generated by the one or more bubbles passing in operation through the detection region to generate a detected signal (S1), and a signal processing arrangement for processing the detected signal (S1) to generate the output signal (S2) indicative of a presence and/or a lack of presence of the one or more bubbles within the detection region.

Optionally, in the underwater detection apparatus, the detection arrangement includes a signal source for interrogating in operation the detection region using interrogating radiation, and one or more sensors for detecting one or more bubbles present in the detection area by way of transmitted portions and/or reflected portions of the interrogating radiation. More optionally, in the underwater detection apparatus, the signal source and the one or more sensors of the detection arrangement are housed within a mutually common unit. More optionally, the signal source for generating the interrogating radiation is adjustable in frequency and/or amplitude to stimulate non-linear resonance in the one or more bubbles, and the output signal (S2) indicative of the one or more bubbles present in the detection region is generated by the detection arrangement from harmonic signal components generated as a consequence of exciting the non-linear resonance in the one or more bubbles.

Optionally, the detection arrangement includes a signal processing unit for measuring a time-of-flight of the interrogating radiation through the detection region and/or an acoustic impedance of the detection region for determining a presence of one or more bubbles rising up within the detection region.

Optionally, the apparatus further includes an arrangement for periodically interrupting in operation a supply of collected bubbles from the bubble concentrating structure to the detection region for enabling the apparatus to differentiate between signals from the detection arrangement indicative of bubbles being present in the detection region, and indicative of bubbles being absent from the detection region. More optionally, in the underwater detection apparatus, the arrangement for periodically interrupting in operation the supply of collected bubbles from the bubble concentrating structure to the detection region includes at least one of:
(i) an actuated valve spatially located in operation below the detection arrangement; and
(ii) an actuated bubble collection arrangement which is operable to release periodically one or more collected bubbles therefrom into the detection region.

Optionally, in the underwater detection apparatus, the detection region further includes in respect thereof a temperature sensor and a pressure sensor for enabling the signal processing arrangement to determine sizes of the one or more bubbles from their measured non-linear resonant frequencies.

Optionally, the apparatus is adapted to be mounted upon a remotely operated vehicle (ROV) for operation.

Optionally, in the underwater detection apparatus, the detection region is provided with a gas analyzer arrangement for analyzing a chemical composition of the one or more bubbles passing in operation through the detection region.

Optionally, in the underwater detection apparatus, the signal processing arrangement is operable to excite the detection arrangement at a frequency in a range of 1 kHz to 10 MHz, more preferable in a range of 10 kHz to 5 MHz, and most preferably in a range of 100 kHz to 1 MHz.

According to a second aspect of the invention, there is provided a method of employing an underwater detection apparatus for detecting a presence of one or more bubbles within an aquatic environment, characterized in that the method includes:
(a) using a first structure including a lower peripheral edge to define an area for the apparatus for collecting the one or more bubbles;
(b) using a second structure for spatially concentrating the one or more bubbles received within the area defined by the lower peripheral edge into a detection region; and
(c) using a detection arrangement for detecting the one or more bubbles concentrated in operation by the second structure into the detection region and generating an output signal (S2) indicative of the one or more bubbles passing through the detection region.

Optionally, the method includes implementing the second structure as a substantially frusto-conical structure for spatially defining a volume in which the one or more bubbles are concentrated in operation.

Optionally, the method includes employing one or more sensors in the detection arrangement for passively detecting sounds generated by the one or more bubbles passing in operation through the detection region to generate a detected signal (S1), and employing a signal processing arrangement for processing the detected signal (S1) to generate the output signal indicative of a presence and/or a lack of presence of the one or more bubbles within the detection region.

Optionally, the method includes employing a signal source of the detection arrangement for interrogating in operation the detection region using interrogating radiation, and employing one or more sensors for detecting one or more bubbles present in the detection area by way of transmitted portions and/or reflected portions of the interrogating radiation. More optionally, the method includes adjusting in frequency and/or amplitude the signal source for generating the interrogating radiation to stimulate non-linear resonance in the one or more bubbles, and generating the output signal indicative of the one or more bubbles present in the detection region from harmonic signal components generated as a consequence of exciting the non-linear resonance in the one or more bubbles.

Optionally, the method further includes using an arrangement for periodically interrupting in operation a supply of collected bubbles from the bubble concentrating structure to the detection region for enabling the apparatus to differentiate between signals from the detection arrangement indicative of bubbles being present in the detection region, and indicative of bubbles being absent from the detection region. More optionally, the method includes implementing the arrangement for periodically interrupting in operation the supply of collected bubbles from the bubble concentrating structure to the detection region to include at least one of:
(i) an actuated valve spatially located in operation below the detection arrangement; and
(ii) an actuated bubble collection arrangement which is operable to release periodically one or more collected bubbles therefrom into the detection region.

Optionally, the method includes utilizing in respect of the detection region a temperature sensor and a pressure sensor for enabling the signal processing arrangement to determine sizes of the one or more bubbles from their measured non-linear resonant frequencies.

Optionally, the method includes implementing the apparatus for mounting upon a remotely operated vehicle (ROV) for operation.

Optionally, the method includes providing the detection region with a gas analyzer arrangement for analyzing a chemical composition of the one or more bubbles passing in operation through the detection region.

Optionally, the method includes operating the signal processing arrangement to excite the detection arrangement at a frequency in a range of 1 kHz to 10 MHz, more preferable in a range of 10 kHz to 5 MHz, and most preferably in a range of 100 kHz to 1 MHz.

According to a third aspect of the invention, there is provided a software product recorded on a machine-readable data storage medium, characterized in that the software product is executable on computing hardware for implementing a method pursuant to the second aspect of the invention.

It will be appreciated that features of the invention are susceptible to being combined in various combination without departing from the scope of the invention as defined by the appended claims.

### DESCRIPTION OF THE DIAGRAMS

Embodiments of the present invention will now be described, by way of example only, with reference to the following diagrams wherein:

FIG. 1 is an illustration of an aquatic environment in which embodiments of the present invention are adapted to operate;

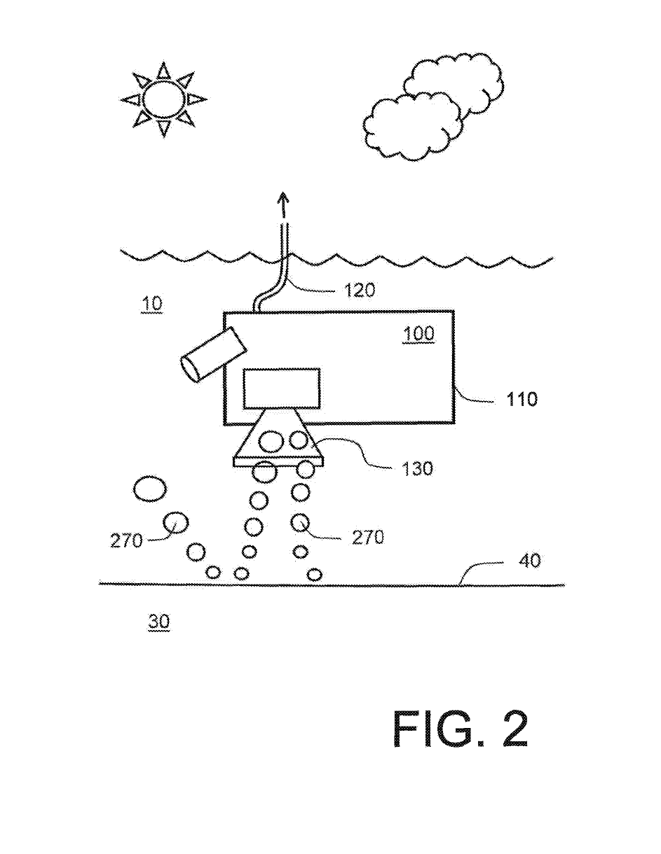

FIG. 2 is an illustration of an example of an apparatus pursuant to the present invention;

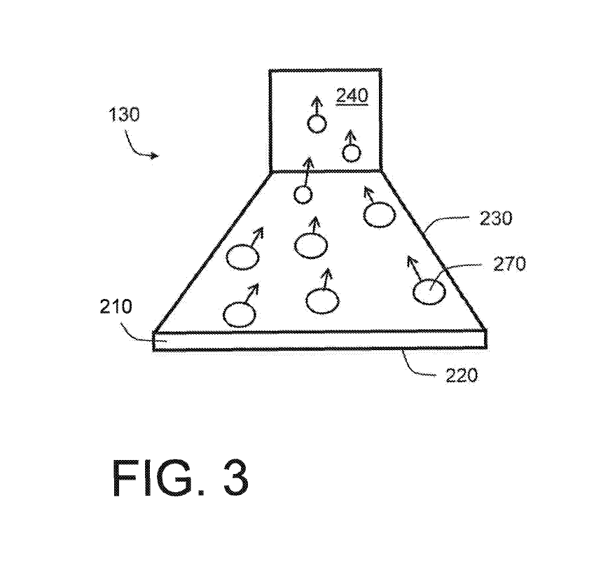

FIG. 3 is an illustration of a sensor arrangement for use in the apparatus of FIG. 2;

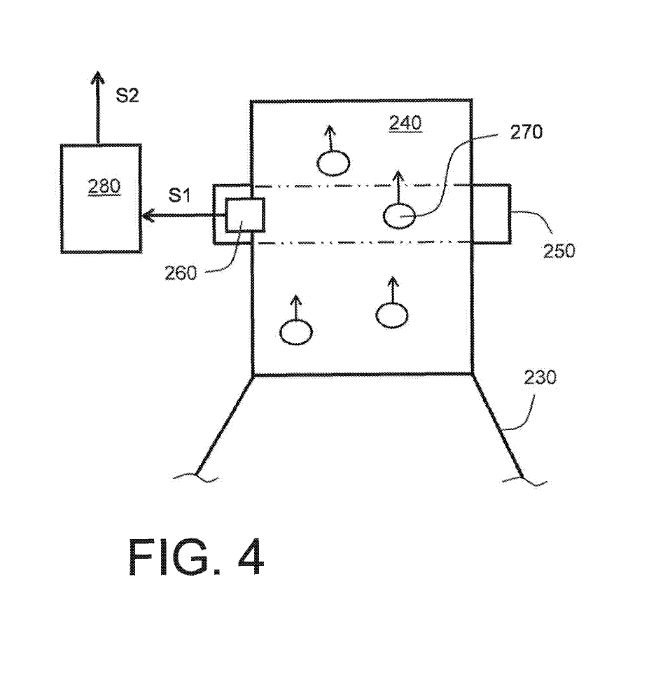

FIG. 4 is an illustration of an alternative sensor arrangement for use in the apparatus of FIG. 2;

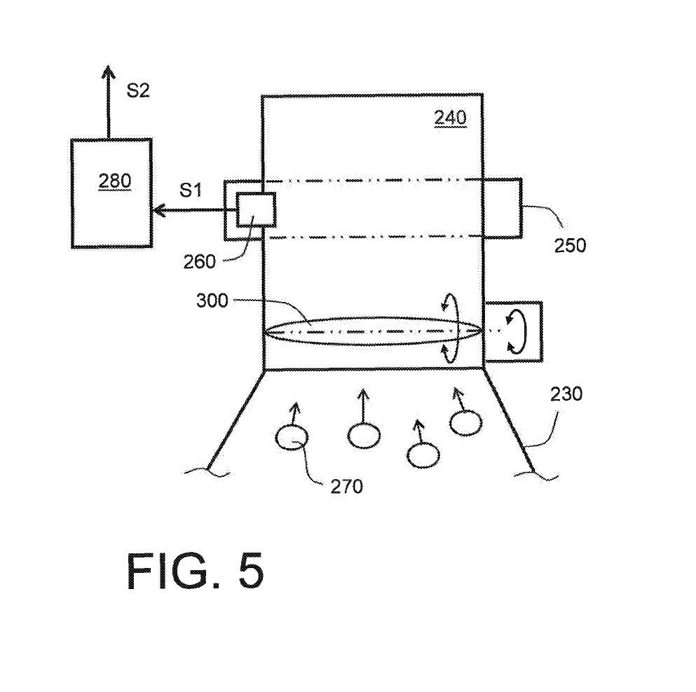

FIG. 5 is an illustration of a neck region of the apparatus of FIG. 2;

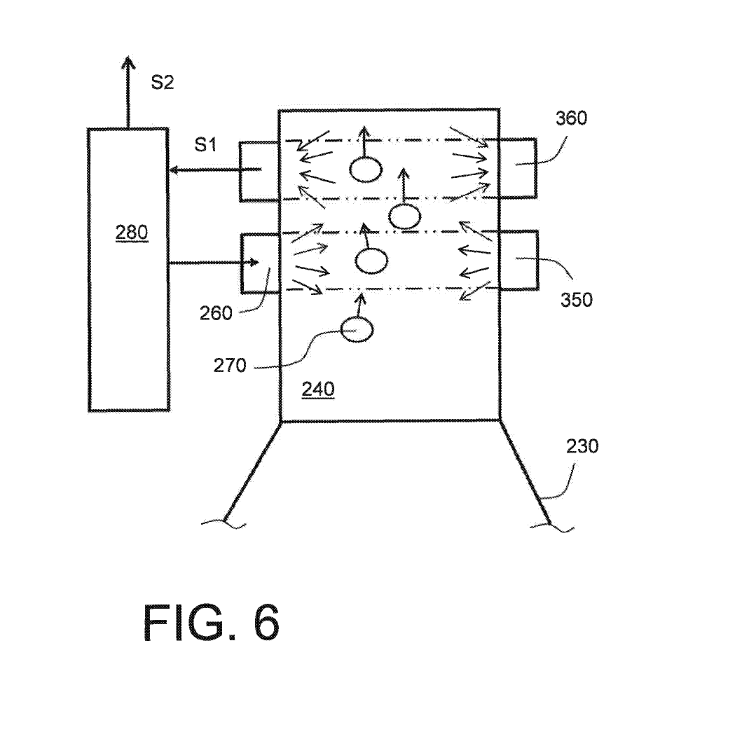

FIG. 6 is an illustration of an optional configuration for a sensor arrangement, wherein one or more acoustic transducers are operable to emit acoustic radiation into the neck region through which fluids flow, for example potentially including one or more bubbles therein;

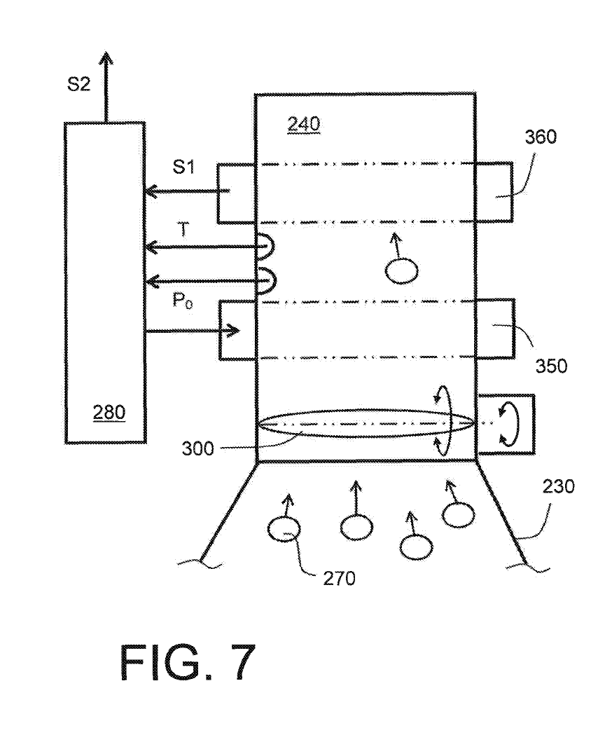

FIG. 7 is an illustration of an annular arrangement of transducers employed for the sensor arrangement of the apparatus in FIG. 2; and

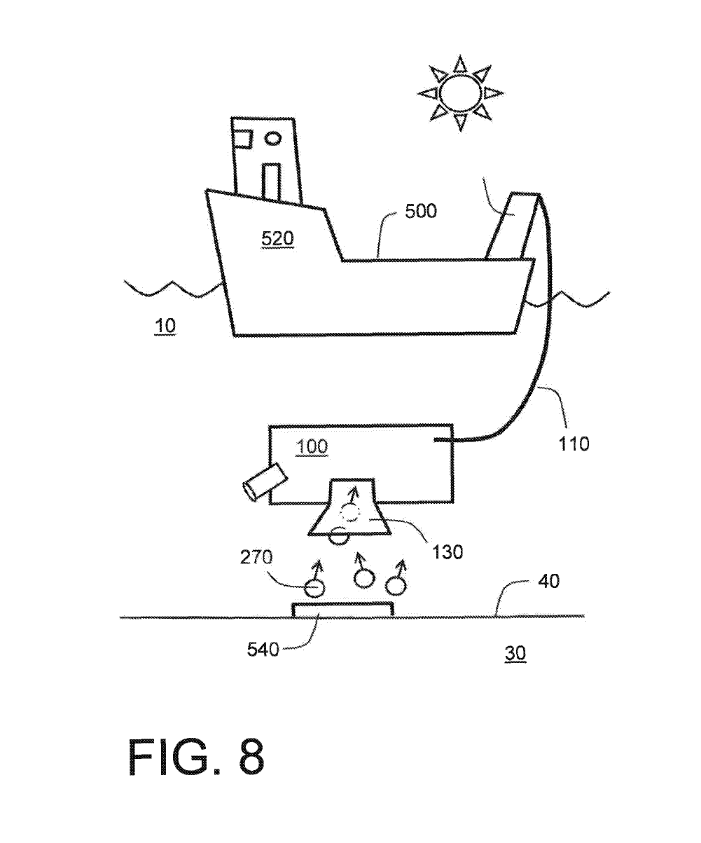

FIG. 8 is an illustration of the apparatus of FIG. 2 together with an aquatic vessel for transporting the apparatus to a location for use.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

Ultrasonic bubble detection is known and provides benefits of detecting bubbles even when particular matter is concurrently present which can cause optical obscuration. A bubble in a liquid will, in general, includes a mixture of permanent gas and vapour, and will be approximately stable over timescales where dissolution and buoyancy may be neglected if a partial pressure of a gas component of the bubble counterbalances constricting pressures due to surface tension and a pressure in liquid surrounding the bubble. An applied acoustic field, namely applied ultrasonic radiation, is capable of driving the bubble into non-linear oscillation, which at small amplitudes approximates to a motion of a single-degree-of-freedom oscillator.

The bubble is thus capable of oscillating and exhibits a natural frequency of resonance υ₀ as defined by Equation 1 (Eq. 1):

$${υ}_{0} = \frac{{ω}_{0}}{2 π} = \frac{1}{2 π {R}_{0}} \sqrt{\frac{3 κ {p}_{0}}{ρ} ( 1 + \frac{2 σ}{{p}_{0} {R}_{0}} ) - \frac{2 σ}{ρ {R}_{0}}} \qquad Eq . 1$$

wherein
ρ=a density of sea water in which the bubble is present;
p₀=a static pressure within the bubble;
σ=a surface tension of the sea water;
κ=a polytropic index; and
R₀=a radius of the bubble.

Earlier studies of bubbles have shown that bubble resonant signatures can be employed to characterized bubbles by exciting them into oscillatory resonant motion. When the motion of the bubble corresponds to a non-linear oscillator, for example as achievable using high intensities of acoustic interrogation, it is found that the bubble is capable of causing frequency multiplication; for example, the bubble is interrogated by acoustic radiation at its resonant frequency υ₀ as defined by Equation 1 (Eq. 1) at an amplitude which causes non-linear oscillation of the bubble, causing the bubble to emit radiation having a second harmonic component at a frequency 2υ₀. Moreover, earlier studies have also shown that interrogating bubbles in the aquatic environment 10 employing signals having acoustic frequencies up to 200 kHz provides measurable results, although higher frequencies have also been employed, for example over a frequency range of 100 kHz to 1 MHz. Water itself may be regarded as an incompressible medium and hence unable to exhibit such resonances; similarly solid particulate matter present in the water is not capable of exhibiting such non-linear resonance.

The present invention concerns an underwater detection apparatus for detecting one or more bubbles arising from an extensive area of seabed 40, or from an extensive area of submerged structure, for example a sea-bed gas pipeline or electrical power cable. The apparatus is indicated generally by 100 in FIG. 2 and includes a main body 110, an umbilical connection 120 to an aquatic surface, and a sensor arrangement 130. The apparatus 100 is capable of being maneuvered in the aquatic environment 10, for example ocean environment, by way of fluid thrusters, propellers and/or actuated vanes. Beneficially, the sensor arrangement 130 includes one or more cameras for inspecting in operation a spatial vicinity of the apparatus 100 when in operation, for example to assist with maneuvering the apparatus 100 when in operation.

The sensor arrangement 130 also includes a sensor arrangement 200 as illustrated in FIG. 3. The sensor arrangement 200 includes a first structure 210 for collecting one or more bubbles, for example implemented as a substantially frusto-conical funnel-shaped structure, including a lower peripheral edge 220, a second structure 230 implemented in a generally upwardly-tapered form for spatially concentrating one or more bubbles received in a bubble collecting area defined by the lower peripheral edge 220, and a neck region 240 for receiving the one or more bubbles concentrated together in the second structure 230; the neck region 240 is also known as a “detection region”. Beneficially, the neck region 240 has an effective transverse cross-sectional area which is smaller than a bubble-collecting area defined by the lower peripheral edge 220. The neck region 240 includes a transducer arrangement 250 for detecting in operation the one or more bubbles collected within the bubble-concentrating region 230 and rising into the neck region 240 by way of their intrinsic buoyancy and/or by assistance of force fluid flow provided by a turbine or similar. Optionally, the second structure 230 is implemented in a substantially frusto-conical manner as aforementioned, although other forms of the region 230 are feasible to employ when implementing the present invention, for example asymmetrical upwardly-tapered structures of curved and/or rectilinear form.

As illustrated in FIG. 4, the transducer arrangement 250 optionally includes at least one acoustic sensor which, in simplest form, is implemented as an aquaphone 260 for listening for movement of one or more collected bubbles 270 through the neck region 240 and generating a corresponding sensor signal S1. The apparatus 100 includes a signal processing unit 280 for processing the signal S1 to generate an output signal S2 indicative of the one or more collected bubbles 270. Optionally, the signal processing unit 280 is operable to filter the signal S1 in respect of signal frequency, and then perform an amplitude and frequency analysis of signal components present in the filtered signal S1 to generate the output signal S2, for example by performing a Fourier spectrum analysis and/or a comparison analysis to predetermined signal templates. Beneficially, neural network analysis of the filtered signal S1 is employed to identify a presence of the one or more bubbles 270. Optionally, the signal processing unit 280 is implemented using computing hardware operable to execute one or more software products stored on machine-readable data storage media; the software products are optionally operable to employ digital recursive filters whose frequency ranges are dynamically modifiable to search for aforesaid components in the signal S1 in various frequency ranges, for example 10 Hz to 100 Hz, 100 Hz to 1 kHz and so forth. In other words, the transducer arrangement 250 in such case is employed for listening passively for bubbling sounds occurring within the neck region 240, and then to analyze the bubbling sounds, namely the signal S1, to confirm with high reliability whether or not one or more bubbles 270 are responsible for generating the bubbling sounds.

As illustrated in FIG. 5, the neck region 240 is beneficially provided with a valve 300 spatially below the transducer arrangement 250, for example below the aquaphone 260. Optionally, the valve 300 is implemented as an actuated butterfly valve, although other types of actuated valves may optionally be employed, for example:
(i) linearly-actuated needle valves and slider valves; and/or
(ii) one or more fluidly-inflatable bodies for obstructing flow of the bubbles when in a fluidly-inflated state, and for allowing in a fluidly deflated state movement of the bubbles 270 into the neck region 240.

The purpose of the valve 300 is to collect one or more bubbles 270 which are then subsequently periodically released for detection using the transducer arrangement 250; alternative arrangements giving rise to such collection of bubbles for periodic release for detection purposes at the transducer arrangement 250 are also within the scope of the present invention, for example by employing one or more actuated bubble-collection cavities which are operable in a first state to collect bubbles received within the area defined by the lower peripheral edge 220, and are operable in a second state to release the collected bubbles for detection via the transducer arrangement 250. The bubble-collection cavities are implemented, for example, using one or more hollow components with associated one or more access apertures which are rotated to switch between the aforesaid first and second states.

In operation, the valve 300 is periodically closed to collect one or more bubbles 270 beneath the valve 300, and then opened to allow the one or more bubbles 270 to progress past the transducer arrangement 250, for example past the aquaphone 260, to generate a clearly discernible bubbling sound in the signal S1 which is periodically processed by the signal processing unit 280 to generate the output signal S2. Optionally, opening and closing of the butterfly valve 300 is under control from the signal processing unit 280. When one or more bubbles 270 are not present, opening and closing the valve 300 has little effect of the signal S1; conversely, when one or more bubbles 270 are present, opening the valve 300 periodically causes a corresponding surge of one or more bubbles 270 when present which is clearly discernible as one or more discernible signal components in the signal S1. Opening and closing of the valve 300 pertains mutatis mutandis to alternative implementations of the valve 300 as elucidated in the foregoing.

Optionally, the sensor arrangement 200 is implemented in an active manner, wherein fluid flowing through the neck region 240 is interrogated using acoustic radiation and corresponding transmitted and/or reflected acoustic signals detected and subsequently processed in the signal processing unit 280; in other words, the transducer arrangement 250 is beneficially implemented to be able to function in an active interrogatory manner for detecting one or more bubbles 270 present in the neck region 240. Optionally, active optical interrogation is employed. In FIG. 6, there is shown an optional configuration for the sensor arrangement 200 wherein one or more acoustic transducers 350 emit acoustic radiation into the neck region 240 through which fluids flow, for example potentially including one or more bubbles 270. The one or more acoustic transducers 350 are coupled to the aforesaid signal processing unit 280 which also includes a signal source arrangement 380 for exciting the one or more transducers 350. Beneficially, the one or more transducers 350 are implemented as one or more piezoelectric devices and/or one or more electromagnetic devices. Optionally, the one or more acoustic transducers 350 are housed in a mutually common housing to the aquaphone 260.

Moreover, there are also included one or more receiving sensors 360 for receiving reflected and/or transmitted radiation from fluid present within the neck region 240. Optionally, an annular arrangement of transducers is employed for implementing one or more of the transducers 350, 360, for example as illustrated in FIG. 7 wherein the one or more transducers 350 are operable to be excited individually or in groups, and the one or more sensors 360 are employed to receive signals individually or in groups. For example, a plurality of sensors 360 are employed to generate a corresponding plurality of signals S1 which are mutually subtracted to remove environmental noise common to the sensors 360 and to isolate differential acoustic signals therefrom which are strongly influenced by the one or more bubbles 270 present within the neck region 240. Such a manner of operation is capable of being used for detecting transversely non-uniform distributions of bubbles 270 within the neck region 240. The one or more acoustic sensors 360 generating the signal S1 are coupled to the signal processing unit 280 which performs signal analysis to generate the output signal S2 indicative of the presence of one or more bubbles 270 within the neck region 240.

In respect of FIG. 6, optionally also in respect of FIG. 7, the signal processing unit 280 is operable to excite the one or more transducers 350 at a range of frequencies and/or at a range of intensities, and simultaneously receive the signal S1 from the one or more sensors 360. The range of frequencies beneficially lies within a range of 1 kHz to 10 MHz, more preferable in a range of 10 kHz to 5 MHz, and most preferably in a range of 100 kHz to 1 MHz. Moreover, the range of frequencies is employed for obtaining information regarding radii R₀ of the one or more bubbles 270 present in the neck region 240; the signal processing unit 280 is operable to apply Equation 1 (Eq. 1) from the foregoing to compute the radii R₀. Optionally, the neck region 240 is furnished with additional sensors for determining various parameters in Equation 1 (Eq. 1), for example the static water pressure p₀ pertaining in respect of the neck region 240, and a temperature T in respect of the neck region 240 from which a density ρ of the water in the neck region 240 can be computed by the signal processing unit 280; optionally, the additional sensors are spatially located locally to the neck region 240. The range of intensities is employed for driving the one or more bubbles 270 when present in the neck region 240 into progressive degrees of non-linear resonance, for example for generating second order and higher harmonics of the acoustic radiation generated by the one or more transducers 350 and detectable by the one or more sensors 360 for generating the signal S1. Optionally, the valve 300 is included spatially beneath the one or more transducers and sensors 350, 360 for periodically interrupting the flow of fluid through the neck region 240, for example for periodically interrupting the one or more bubbles 270, wherein a lack of the one or more bubbles 270 in the neck region 240 as a result of the valve 300 preventing them rising into a spatial vicinity of the one or more transducers and sensors 350, 360 results in a lack of harmonic components present in the signal S1 as the acoustic radiation emitted from the one or more transducers 350 is varied in intensity.

Operation of the apparatus 100 will now be described with reference to FIG. 2 to FIG. 8. As illustrated in FIG. 8, the apparatus 100 is transported on a deck 500 of a ship 520 to an aquatic location 530 whereat one or more bubbles 270 within the aquatic environment 10 are to be investigated there. Such one or more bubbles 270 potentially arise from one or more of: the geological formation 30 at the location 530, the seabed 40 at the location 530; the geological formation 30; apparatus 540 included on the seabed 40, for example a pipeline and/or an electrical cable and/or a sunken aquatic vessel. For example, the present invention is useful when an electrically-screened underwater cable develops an insulation fault which is not detectable by way of electromagnetic radiation detection on account of an outer electromagnetic Earthed shield of the cable being intact, but which is detectable by way of failing internal cable insulation giving rise to heating and charring of plastics material insulation causing one or more bubbles of gas to be generated.

When the ship 520 arrives at the location 530, the apparatus 100 is lifted into the aquatic environment 10, for example using a crane mounted onto the deck 500. The apparatus 10 moves around within the aquatic environment 10 whilst searching for the one or more bubbles 270 by way of the first structure 210 collecting one or more upwardly-mobile bubbles 270 and guiding them via the second structure 230 to the neck region 240 and thereby to the transducer arrangement 250 for detection as described in the foregoing. The apparatus 100 is conveniently implemented as a remotely operated vehicle (ROV), for example in a manner of a miniature submarine or similar. The apparatus 100 is beneficially operable to manoeuvre itself via remote control from the ship 520 and/or to manoeuvre itself autonomously by way of local control implemented within the apparatus 100, for example via a computer arrangement operable to execute software for guiding the apparatus 100 to search systematically for one or more bubbles 270 within a defined spatial region within an aquatic environment 10. Optionally, the computer arrangement is operable to guide the apparatus 100 to implement a general search for bubbles in a first mode of operation, and to perform a thorough search within a given region in a second mode of operation in an event that one or more bubbles 270 are detected in the first mode of operation. Such a manner of functioning of the apparatus 100 potentially enables large areas of the seabed 40 to be mapped out when searching for features and/or structures giving rise to one or more bubbles 270. For example, in the first mode, gas bubbles 270 are detected, whereas a more detailed analysis including chemical analysis of the collected bubbles 270 is performed in the second mode.

Optionally, the neck region 240 has a horizontal cross-sectional area which is less than 50% of a bubble-collecting area defined by the lower peripheral edge 220, more optionally less than 25% of the bubble-collecting area of the lower peripheral edge 220, and most optionally less than 10% of the bubble-collecting area of the lower peripheral edge 220. Optionally, as aforementioned, the second structure 230 is implemented as a substantially frusto-conical upwardly-tapered structure, a generally upwardly-tapered structure, an asymmetrical upwardly-tapered structure, an upwardly-tapered structure whose spatial extent can be dynamically altered in operation, or any combination of such optionally implementations.

Optionally, the apparatus 100 includes an arrangement for collecting the one or more bubbles 270 after they have passed through the neck region 240 for subsequent analysis for determine their chemical nature, for example methane, breakdown gaseous products from overheated electrical plastics material insulation, air bubbles from a sunken damaged submarine and so forth. Optionally, analysis of the one or more collected bubbles 270 is performed when the apparatus 100 returns to its corresponding ship 520 and associated deck 500. Alternatively, the apparatus 100 includes one or more gas analyzers spatially integrated therewith for analyzing a chemical composition of the one or more collected bubbles 270 from the detection region 240, for example in real-time; such one or more gas analyzers beneficially include at least one of infra-red optical sensors, electrochemical sensors, combustion sensors (for example Pellistors), semiconductor gas sensors, acoustic gas sensors.

The apparatus 100 is beneficially adapted to measure oil bubbles present in water and rising up into the neck region 240, for example arising from leaks from underwater oil pipelines and from leaking underwater oil valves, for example associated with “Christmas Tree” underwater well heads. Such oil bubbles exhibit highly viscously damped behaviour devoid of resonance effects as a function of ultrasonic radiation interrogating intensity. However, such oil bubbles have a density which is often less than saline water, resulting in them moving into the neck region 240. The transducer arrangement 250 is beneficially optionally provided with an acoustic transmitter transducer and a corresponding receiver transducer for measuring an acoustic impedance of the neck region 240 a function of time. As oil bubbles enter and rise through the neck region 240 in operation, coupling efficiency of acoustic energy propagating from the transmitter transducer to the receiver transducer is modulated. For example, if the transmitter transducer is excited using a signal of constant amplitude and frequency, a corresponding output signal from the receiver transducer varies as oil bubbles enter into the neck region 240. By measuring temporal variations in the output signal from the receiver transducer, for example in the signal processing unit 280 by recursive filtering, Fast Fourier Transform (FFT) or similar, spectral signatures for gas bubbles and oil bubbles are susceptible to being indentified. Optionally, the valve 300 is used in a closed state to collect gas and oil bubbles therebelow, and then switched to an open state to allow the gas bubbles to rise first, followed by the oil bubbles later. Temporal characteristics of acoustic coupling between the transmitter transducer and the receiver transducer as firstly gas bubbles and thereafter oil bubbles rise in the neck region 240 is able to provide valuable information regarding leaks and other processes occurring underwater. In addition, or alternatively, time of flight of pulses of acoustic radiation to propagate from the transmitter transducer to the receiver transducer to determine a density of the neck region 240. Temporal variations in the time of flight are monitored by the signal processing unit 280 to identify and nature of bubbles, either gas or oil, propagating through the neck region 240.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. An underwater detection apparatus for detecting a presence of one or more bubbles within an aquatic environment, the apparatus includes a first structure including a lower peripheral edge for defining an area over which said apparatus is operable to collect the one or more bubbles, a second structure for spatially concentrating the one or more bubbles received within the area defined by the lower peripheral edge into a detection region, and a detection arrangement for detecting the one or more bubbles concentrated in operation by the bubble concentrating structure passing into the detection region and generating an output signal indicative of the one or more bubbles passing through the detection region.

2. An underwater detection apparatus as claimed in claim 1, wherein the apparatus is adapted to detect at least one of: one or more gas bubbles, one or more oil bubbles.

3. An underwater detection apparatus as claimed in claim 1, wherein the second structure is implemented as a substantially frusto-conical structure for spatially defining a volume in which the one or more bubbles are concentrated in operation.

4. An underwater detection apparatus as claimed in claim 1, wherein the detection arrangement includes one or more sensors for passively detecting sounds generated by said one or more bubbles passing in operation through the detection region to generate a detected signal, and a signal processing arrangement for processing the detected signal to generate said output signal indicative of a presence and/or a lack of presence of the one or more bubbles within the detection region.

5. An underwater detection apparatus as claimed in claim 1, wherein said detection arrangement includes a signal source for interrogating in operation the detection region using interrogating radiation, and one or more sensors for detecting one or more bubbles present in the detection area by way of transmitted portions and/or reflected portions of the interrogating radiation.

6. An underwater detection apparatus as claimed in claim 5, wherein said signal source and said one or more sensors of said detection arrangement are housed within a mutually common unit.

7. An underwater detection apparatus as claimed in claim 5, wherein the detection arrangement includes a signal processing unit for measuring a time-of-flight of the interrogating radiation through the detection region and/or an acoustic impedance of the detection region for determining a presence of one or more bubbles rising up within the detection region.

8. An underwater detection apparatus as claimed in claim 5, wherein the signal source for generating the interrogating radiation is adjustable in frequency and/or amplitude to stimulate non-linear resonance in said one or more bubbles, and said output signal indicative of the one or more bubbles being present in the detection region is generated by the detection arrangement harmonic signal components generated as a consequence of exciting said non-linear resonance in the one or more bubbles.

9. An underwater detection apparatus as claimed in claim 1, wherein said apparatus further includes an arrangement for periodically interrupting in operation a supply of collected bubbles from the bubble concentrating structure to the detection region for enabling said apparatus to differentiate between signals from the detection arrangement indicative of bubbles being present in the detection region, and indicative of bubbles being absent from the detection region.

10. An underwater detection apparatus as claimed in claim 9, wherein said arrangement for periodically interrupting in operation the supply of collected bubbles from the first structure to the detection region includes at least one of:
(i) an actuated valve spatially located in operation below said detection arrangement; and
(ii) an actuated bubble collection arrangement which is operable to release periodically one or more collected bubbles therefrom into the detection region.

11. An underwater detection apparatus as claimed in claim 1, wherein said detection region further includes in respect thereof a temperature sensor and a pressure sensor for enabling the signal processing arrangement to determine sizes of the one or more bubbles from their measured non-linear resonant frequencies.

12. An underwater detection apparatus as claimed in claim 1, wherein said apparatus is adapted to be mounted upon a remotely operated vehicle (ROV) for operation.

13. An underwater detection apparatus as claimed in claim 1, wherein the detection region is provided with a gas analyzer arrangement for analyzing a composition of the one or more bubbles passing in operation through the detection region.

14. An underwater detection apparatus as claimed in claim 1, wherein the signal processing arrangement is operable to excite the detection arrangement at a frequency in a range of to 10 MHz, more preferable in a range of 10 kHz to 5 MHz, and most preferably in a range of 100 kHz to 1 MHz.

15. A method of employing an underwater detection apparatus for detecting a presence of one or more bubbles within an aquatic environment, wherein characterized in that said method includes:
(a) using a first structure including a lower peripheral edge to define an area for said apparatus for collecting the one or more bubbles;
(b) using a second structure for spatially concentrating the one or more bubbles received within the area defined by the lower peripheral edge into a detection region; and
(c) using a detection arrangement for detecting the one or more bubbles concentrated in operation by the second structure into the detection region and generating an output signal indicative of the one or more bubbles passing through the detection region.

16. A method as claimed in claim 15, wherein said method includes employing said signal processing arrangement to detect at least one of: one or more gas bubbles, one or more oil bubbles.

17. A method as claimed in claim 15, wherein said method includes implementing said second structure as a substantially frusto-conical structure for spatially defining a volume in which the one or more bubbles are concentrated in operation.

18. A method as claimed in claim 15, wherein said method includes employing one or more sensors in the detection arrangement for passively detecting sounds generated by said one or more bubbles passing in operation through the detection region to generate a detected signal, and employing a signal processing arrangement for processing the detected signal to generate said output signal indicative of a presence and/or a lack of presence of the one or more bubbles within the detection region.

19. A method as claimed in claim 15, wherein said method includes employing a signal source of said detection arrangement for interrogating in operation the detection region using corresponding interrogating radiation, and employing one or more sensors for detecting one or more bubbles present in the detection area by way of transmitted portions and/or reflected portions of the interrogating radiation.

20. A method as claimed in claim 19, wherein said method includes employing a signal processing unit in the detection arrangement for measuring a time-of-flight of the interrogating radiation through the detection region and/or an acoustic impedance of the detection region for determining a presence of one or more bubbles rising up within the detection region.

21. A method as claimed in claim 19, wherein said method includes adjusting in frequency and/or amplitude the signal source for generating the interrogating radiation to stimulate non-linear resonance in said one or more bubbles, and determining from said signal indicative of the one or more bubbles present in the detection region harmonic signal components generated as a consequence of exciting said non-linear resonance in the one or more bubbles for generating the output signal for providing the output signal.

22. A method as claimed in anyone of claim 15, wherein said method further includes using an arrangement for periodically interrupting in operation a supply of collected bubbles from the bubble concentrating structure to the detection region for enabling said apparatus to differentiate between signals from the detection arrangement indicative of bubbles being present in the detection region, and indicative of bubbles being absent from the detection region.

23. A method as claimed in claim 22, wherein the method includes implementing the arrangement for periodically interrupting in operation the supply of collected bubbles from the second structure to the detection region to include at least one of:
i) an actuated valve spatially located in operation below said detection arrangement; and
(ii) an actuated bubble collection arrangement which is operable to release periodically one or more collected bubbles therefrom into the detection region.

24. A method as claimed in anyone of claim 15, wherein said method includes utilizing in respect of the detection region a temperature sensor and a pressure sensor for enabling the signal processing arrangement to determine sizes of the one or more bubbles from their measured non-linear resonant frequencies.

25. A method as claimed in anyone of claim 15, wherein said method includes implementing said apparatus for mounting upon a remotely perated vehicle (ROV) for operation.

26. A method as claimed in anyone of claim 15, wherein characterized in that the method includes providing said detection region with a gas analyzer arrangement for analyzing a composition of the one or more bubbles passing in operation through the detection region.

27. A method as claimed in anyone of claim 15, wherein said method includes operating the signal processing arrangement to excite the detection arrangement at a frequency in a range of 1 kHz to 10 MHz, more preferable in a range of 10 kHz to 5 MHz, and most preferably in a range of 100 kHz to 1 MHz.

28. A software product recorded on a machine-readable data storage medium, wherein said software product is executable on computing hardware for implementing a method as claimed in any of claim 15.
